(19) United States
(12) Patent Application Publication
(10) Pub. No.: US 2014/0326003 A1
(43) Pub. Date: Nov. 6, 2014

(54) DEVICE AND METHOD FOR TRANSFERRING HEAT IN A FOOD STORAGE PAN

(71) Applicant: THE DELFIELD COMPANY, LLC, Mt. Pleasant, MI (US)

(72) Inventors: Darrel Jay WALKER, Mount Pleasant, MI (US); Harry Edward WING, Midland, MI (US); Travis James KRCHMAR, Harrison, MI (US)

(73) Assignee: THE DELFIELD COMPANY, LLC, Mt. Pleasant, MI (US)

(21) Appl. No.: 14/267,474

(22) Filed: May 1, 2014

Related U.S. Application Data
(60) Provisional application No. 61/818,199, filed on May 1, 2013.

(51) Int. Cl. A23L 3/36

(52) U.S. Cl. CPC A23L 3/36
USPC 62/62; 62/440

(57) ABSTRACT

The food storage device of the present disclosure includes a cover that can be connected to a food pan, and which at least partially separates refrigerant coils from surrounding insulating foam. This helps to prevent corrosion of the coils caused by condensation reacting with insulating foam, and also helps to prevent the coils from separating from the pan.

### CROSS-REFERENCE TO RELATED APPLICATIONS

The present application claims the benefit of U.S. Provisional Application No. 61/818,199, filed on May 1, 2013, which is herein incorporated by reference.

### BACKGROUND OF THE DISCLOSURE

1. Field of the Disclosure

The present disclosure relates to ways to cool and/or heat food in storage pans. More particularly, the present disclosure relates to devices and methods for eliminating or mitigating decay caused by refrigerant tube corrosion.

2. Description of the Related Art

In food storage applications, the food may be placed in a deep pan. A refrigerant system can include refrigerant coils that are wrapped around the sides of the pan, to transfer heat to (i.e., heating the food) or away from (i.e, cool) the food. A foam insulation layer can be applied, sprayed, or poured into a chamber surrounding the coils, to reduce heat exchange between the coils and the ambient environment. In these food pans, however, condensation can form on the coils, and the interaction of the coils, moisture, and foam can corrode the coils, leading to leaks and heat loss. In addition, when the foam is poured into the chamber, it can cause the coils to separate from contacting the food pan, which further reduces heating or cooling efficiency.

### SUMMARY OF THE DISCLOSURE

The present disclosure provides a device and method for containing and/or securing refrigeration coils in such a way that it prevents or mitigates corrosion of the coils and separation of the coils from the food pan. A cover or channel can be placed over the refrigeration coils to separate them from insulation foam in a surrounding chamber. This cover prevents coil condensation from reacting with foam, and corroding the coils. Furthermore, the cover prevents the coils from separating from the pan when the foam is added to the chamber. A thermally conductive substance can be placed in the chamber formed between the cover and the coils, to improve heat transfer between the coils and the pan.

Thus, in one embodiment, the present disclosure provides a food storage device comprising a food pan. The food pan comprises one or more vertical walls that define an interior space for storing food products therein. A refrigerant coil is connected to an exterior surface of at least one of the vertical walls. An outer wall surrounds the food pan, so that a first chamber is between the outer wall and the exterior surface of the vertical walls. A cover is connected to the exterior surface of the food pan. The cover covers the refrigerant coil, and at least partially isolates the refrigerant coil from the first chamber.

In another embodiment, the present disclosure provides a method of transferring heat to or away from food in a pan. The method comprises the steps of: connecting a refrigerant coil to an exterior surface of a food pan that stores the food; covering the coil with a cover; connecting the cover to the exterior surface of the food pan; placing the food pan with the coil and the cover connected thereto in a basin formed by an outer wall; placing an insulating material in a first chamber formed by the outer wall, the cover, and the food pan; and passing refrigerant through the coil, to transfer heat with the food in the pan. The cover at least partially isolates the coil from the first chamber.

### BRIEF DESCRIPTION OF THE DRAWINGS

FIG. 1 shows a top, perspective view of a food pan of the present disclosure, displaying a first embodiment of the cover.

FIG. 2 shows a second, top, perspective view of the food pan of FIG. 1, with a portion of the cover removed.

FIG. 3 is a close up perspective view of a corner of the food pan of FIG. 1.

FIG. 4 is a cross-sectional view of the food pan of FIG. 1.

FIG. 5 is a cross-sectional view of a food pan of the present disclosure, showing a second embodiment of the cover.

FIG. 6 is a top, perspective view of the food pan of FIG. 5.

### DETAILED DESCRIPTION OF THE DISCLOSURE

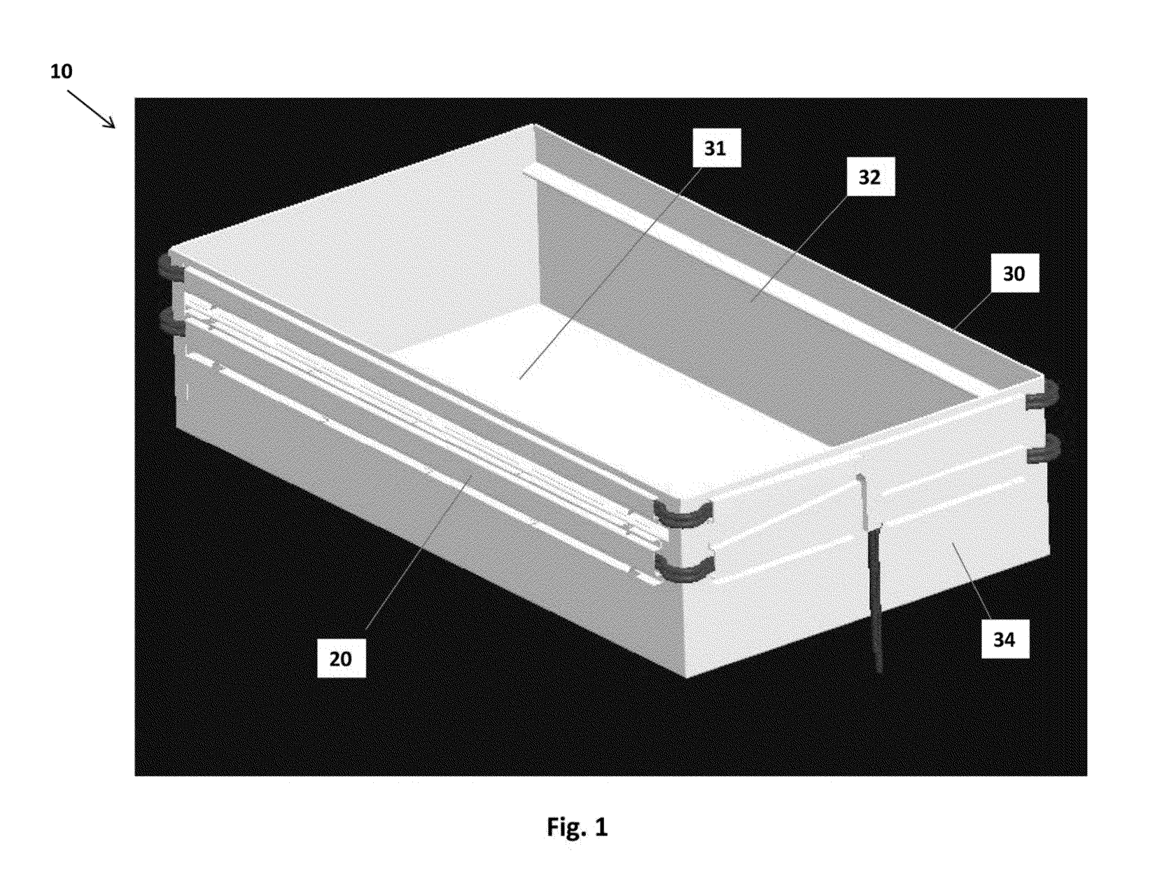

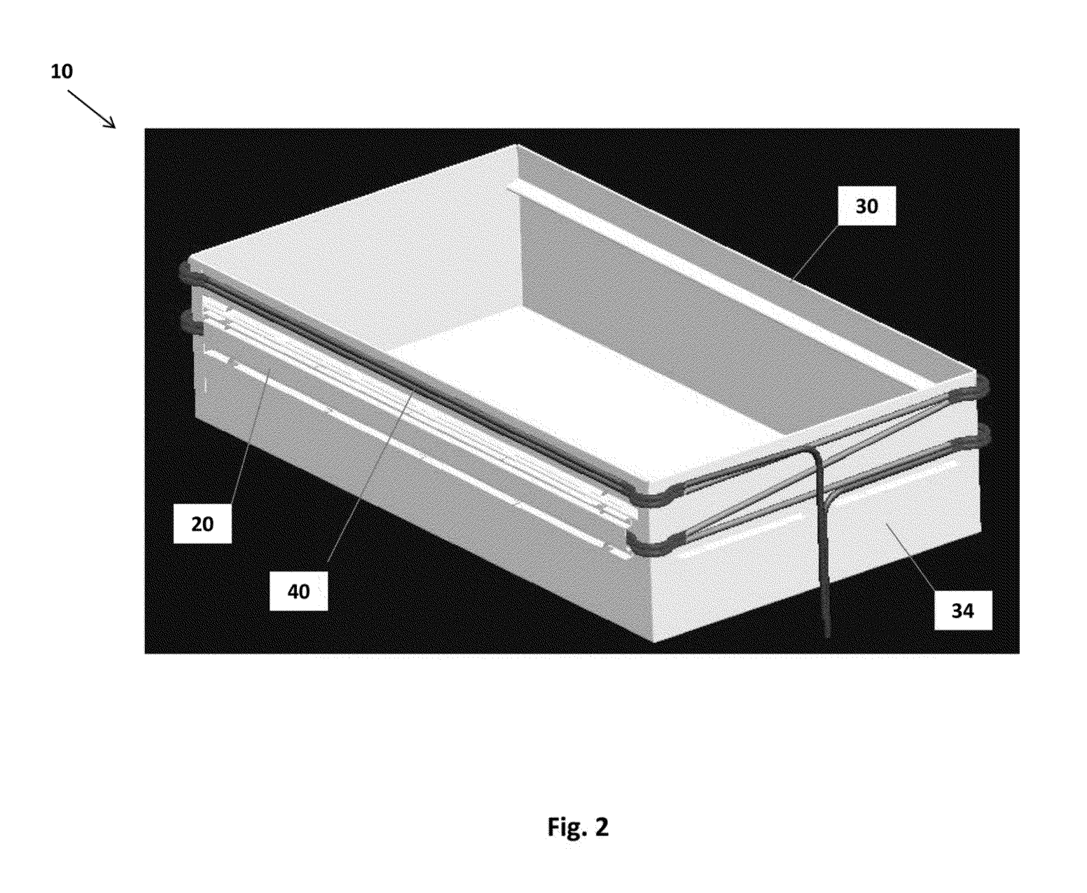

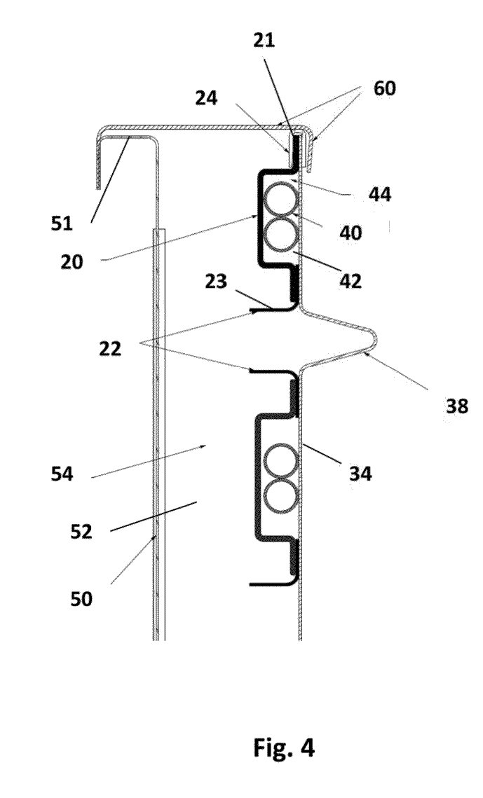

Referring to FIGS. 1-4, food storage device 10 of the present disclosure is shown. Device 10 has one or more covers 20, pan 30, one or more refrigeration coils 40, and outer wall 50. When in use, food is placed within interior space 32 of pan 30 to be cooled or heated. One or more coils 40 wrap around the exterior of wall 34 of pan 30, and coils 40 contact pan 30 to ensure efficient heat transfer. Coolant passes through coils 40, exchanging heat with the food in pan 30. As shown in FIG. 4, a first chamber 52 is formed in the space between outer wall 50, cover 20 and pan 30. An insulating material 54 is added (e.g., blown or poured foam) into first chamber 52. Covers 20 at least partially cover one or more refrigeration coils 40, and at least partially isolate them from first chamber 52 and insulating material 54.

Advantageously, cover 20 separates insulating material 54 from coils 40, to eliminate any corrosive effects that may arise from condensation on coils 40 reacting with insulating material 54. Furthermore, as cover 20 is already in place when insulating material 54 is added to first chamber 52, cover 20 protects coils 40 from separating from the wall of pan 30. Thus, even though device 10 of the present disclosure requires additional components over currently available pans, and some additional assembly, it provides improved performance.

Pan 30 of the present disclosure can have any number of shapes, such as square, rectangular, or round. One or more walls can project up from a bottom surface of the pan 30, to define an interior space where the food can be placed for cooling or heating. In the shown embodiment, pan 30 is rectangular, with four walls 34. Each of walls 34 projects upward from bottom surface 31 and connect to one another at corners of pan 30 as shown, to define interior space 32. By “exterior” surface, the present disclosure means that coils 40 are wrapped around walls 34 on an opposite side of each wall 34 from interior space 32.

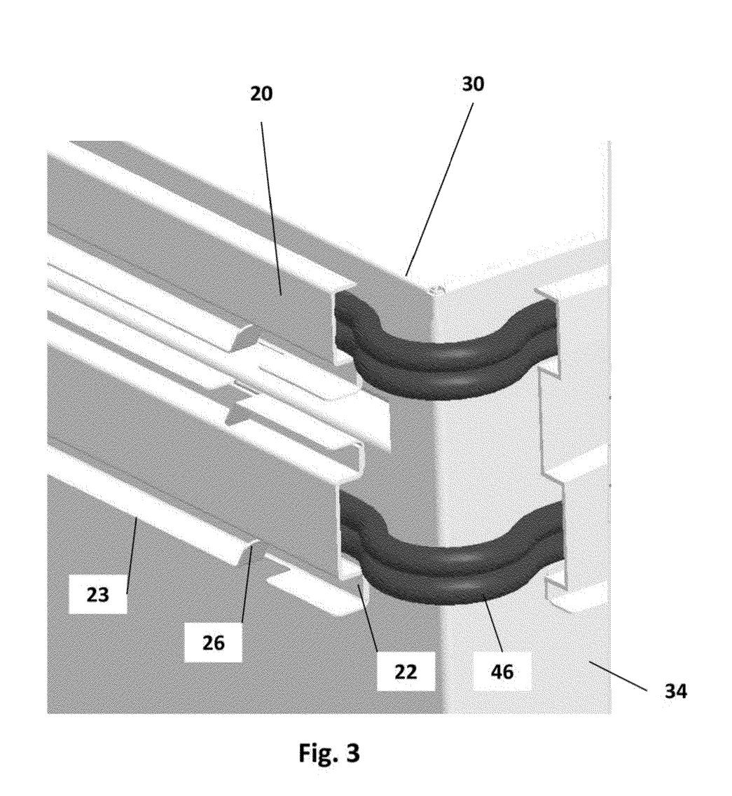

Referring specifically to FIG. 4, device 10 also has one or more holding clips 22, which are connected to the exterior of wall 34 and project out into first chamber 52. To connect cover 20 to wall 34, a containment clip 24 can be placed over the top of an upper edge 21 of cover 20 and wall 34, holding cover 20 up against wall 34. The bottom edge of cover 20 contacts or abuts against a holding clip 22, which can have a horizontal flange 23 projecting out into first compartment 52. As shown in FIG. 3, holding clips 22 can have one or more tabs 26. To secure cover 20 in position, the user pushes tabs 26 up or down, as shown. Thus, cover 20 is secured in place very easily, with no need for fasteners or adhesives. The present disclosure does contemplate that fasteners or adhesives may be used to connect cover 20 to wall 34.

In the embodiment of FIGS. 1-4, there are two covers 20, each of which covers two refrigerant coils 40. The present disclosure contemplates one or more covers 20 for device 10. Each cover 20 can cover one or more of coils 40.

As shown in FIG. 4, a second compartment 42 is formed between cover 20 and wall 34, where coils 40 are located. A coolant fluid, resin, gel, or solid 44 can be placed in second compartment 42, to ensure maximum heat transfer between coils 40 and wall 34. The coolant 44 can be a resin or a petroleum-based semi-solid such as thermal mastic, or a fluid such as glycol or water.

After cover(s) 20 is connected to pan 30 in the manner described above, the assembly can be placed into a basin formed by outer wall 50, so that first chamber 52 is formed. Insulating material 54 is placed in first chamber 52. A top member 60 can be placed over containment clip 24 and an upper edge 51 of outer wall 50, to seal first compartment 52.

As shown in FIGS. 1-3, coils 40 can remain uncovered at the corners of pan 30. To prevent the above-described problem of corrosion, at these corners coils 40 can have a protective coating 46 thereon. Coating 46 can be a substance such as a cellulose acetate film or a thermal plastic rubber. Since coils 40 do not directly contact pan 30 in the corners, any adverse effect the coating 46 may have on heat transfer is not critical.

The materials used in device 10 can be those suitable for contact with food where needed, such as stainless steel or plastic, or others suitable for a particular use. In one embodiment, top member 60, holding clip 22, and pan 30 are made of stainless steel. Outer body 50 can be galvanized steel. Clip 24 can be made of polyethylene. Cover 20 can be made of plastic or aluminum. The foam may be a polyurethane foam, and refrigerant coils 40 can be made of copper, stainless steel, or aluminum.

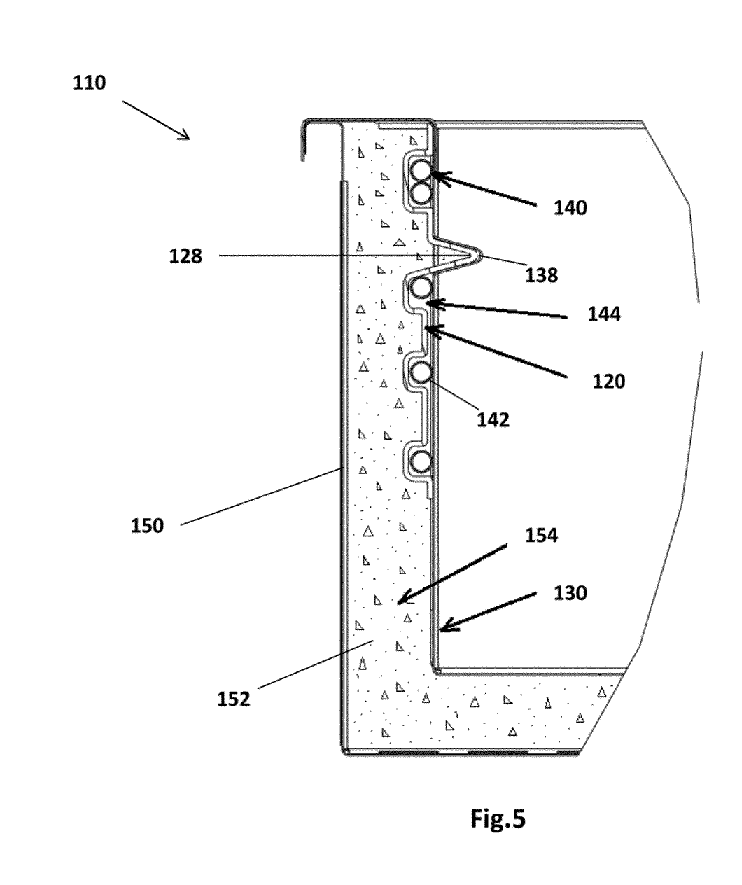

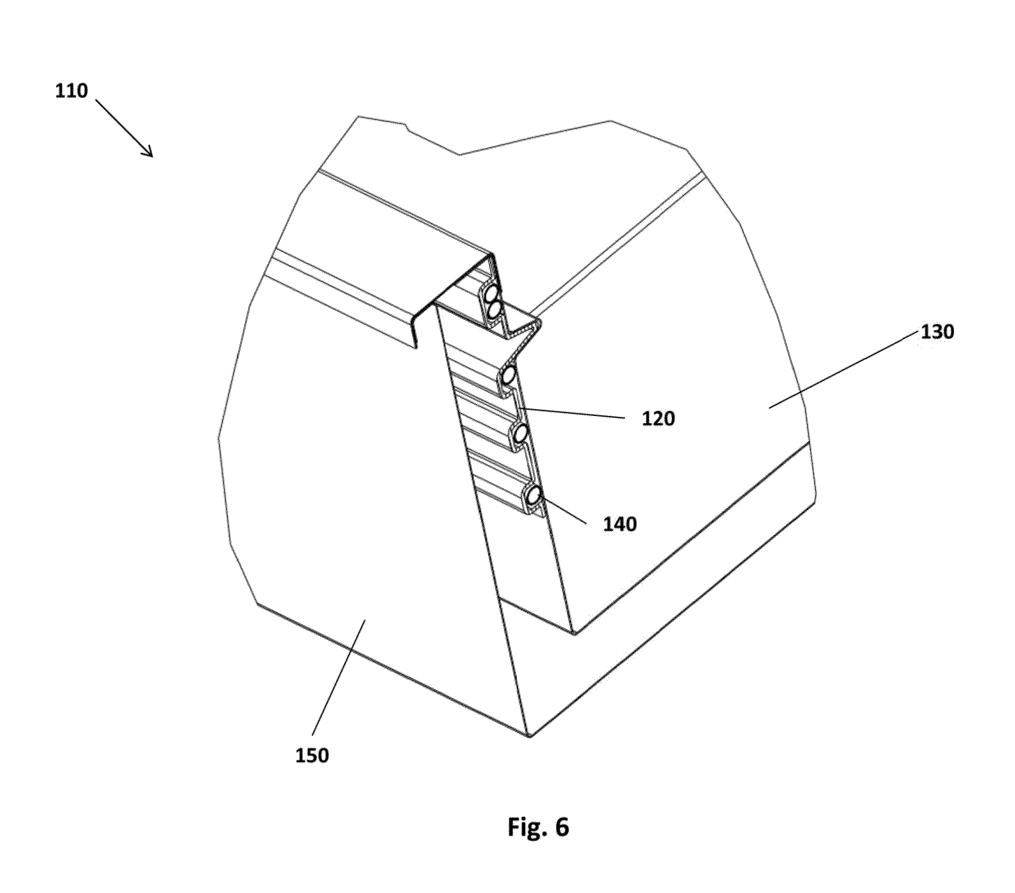

Referring to FIGS. 5 and 6, a food storage device 110 is shown. Device 110 functions in a similar manner to device 10, with the differences discussed below, and has similarly numbered components. Device 110 has cover 120, pan 130, refrigerant coils 140, and outer wall 150. Cover 120 is one single continuous piece, and has multiple pockets 142 for covering coils 140. As shown, each of pockets 142 can cover one or more coils 140. Cover 120 is advantageous in that the one-piece construction can cover multiple groupings of coils 140, and is easier to assemble than a multi-piece cover. Cover 120 can be connected to pan 130 in the same ways as cover 20 is connected to pan 30 in device 10. Foam 154 is placed within first compartment 152, between outer wall 150, pan 130, and cover 120.

Cover 120 also differs from cover 20 in that it has an indented portion 128 along a length thereof. This indent corresponds to indent 138 of pan 130, which can be used to hang individual food storage pans (not shown). The matching indents 128 and 138 can help to ensure a tight fit between cover 120 and pan 130. A similar indent 38 can be in pan 30 of device 10, though cover 20 does not have a similar indent thereon.

A method of cooling or heating food in a pan according to the present disclosure can comprise the following steps: connecting refrigerant coils to an exterior surface of a food pan that stores the food to be cooled or heated; covering the coils with the cover(s) described above; connecting the cover(s) to the exterior surface of the food pan; placing the food pan with the coils and cover(s) connected thereto in a basin formed by an outer wall; placing insulating material (e.g., foam) in a first chamber formed by the outer wall, cover(s), and food pan; and passing refrigerant through the coils, to heat or cool the food in the pan. The method can also comprise the step of adding a cooling material within a second chamber formed by the cover(s) and food pan. The adding a cooling material to the second chamber step can take place at any time in the method, such as immediately before or after the connecting step.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A food storage device, comprising:
a food pan, said food pan comprising one or more vertical walls that define and surround an interior space for storing food products therein;
a refrigerant coil connected to an exterior surface of at least one of said vertical walls, wherein said exterior surface is on an opposite side of said vertical walls from said interior space;
an outer wall surrounding said food pan, so that a first chamber is between said outer wall and said exterior surface of said vertical walls; and
a cover connected to said exterior surface of said food pan, wherein said cover covers said refrigerant coil, and at least partially isolates said refrigerant coil from said first chamber.

2. The food storage device of claim 1, further comprising a second chamber between said cover and said exterior surface of said vertical walls.

3. The food storage device of claim 2, further comprising a conducting fluid in said second chamber.

4. The food storage device of claim 1, further comprising an insulating medium in said first chamber.

5. The food storage device of claim 4, wherein said insulating medium is foam.

6. The food storage device of claim 1, wherein said refrigerant coil is a plurality of refrigerant coils.

7. The food storage device of claim 6, wherein said cover is a single, unitary component that at least partially covers each of said plurality of refrigerant coils.

8. The food storage device of claim 6, wherein said cover is a plurality of covers, and each of said plurality of covers at least partially covers at least one of said plurality of refrigerant coils.

9. The food storage device of claim 1, wherein said refrigerant coil has a protective coating therein at a portion not covered by said cover.

10. A method of transferring heat to or away from food in a pan, comprising:
connecting a refrigerant coil to an exterior surface of a food pan that stores the food;
covering said coil with a cover;
connecting said cover to said exterior surface of said food pan;
placing said food pan with said coil and said cover connected thereto in a basin formed by an outer wall;
placing an insulating material in a first chamber formed by said outer wall, said cover, and said food pan; and
passing refrigerant through said coil, to transfer heat with the food in said pan,
wherein said cover at least partially isolates said coil from said first chamber.

11. The method according to claim 10, further comprising the step of adding a cooling material to a second chamber formed by said exterior surface of said food pan and said cover,
wherein said adding step is performed either immediately before or after said connecting step.
